(19) United States
(12) Patent Application Publication
(10) Pub. No.: US 2008/0310464 A1
(43) Pub. Date: Dec. 18, 2008

(54) Device for Generating and Modulating a High-Frequency Signal

(76) Inventor: Thomas Schneider, Wilhelmshorst (DE)

Correspondence Address: KENYON & KENYON LLP, ONE BROADWAY, NEW YORK, NY, 10004, US

(21) Appl. No.: 11/659,655

(22) PCT Filed: Jul. 23, 2005
(86) PCT No.: PCT/DE05/01302

§ 371 Date: Oct. 16, 2007

(30) Foreign Application Priority Data
Aug. 3, 2004 (DE) 10 2004 037 549.6

(51) Int. Cl. H01S 3/10

(52) U.S. Cl. 372/22; 372/28

(57) ABSTRACT

A device and method involving a plurality of lasers for generating and modulating a tunable, high-frequency signal for a wireless communication system, including an optical waveguide, may be produced using standard components of optical communication technology. A signal source may be provided which generates an optical signal and is disposed on one side of the optical waveguide. At least one means is provided for generating harmonic waves of this signal, which propagate as frequency mix in the optical waveguide. Two pump lasers are provided for the injection of pump waves on an opposite side of the optical waveguide, which are adapted so that together they amplify two harmonic waves of the frequency mix by stimulated Brillouin scattering. The rest of the harmonic waves are attenuated by damping in the optical waveguide. The two amplified harmonic waves are superposed in a photo element in heterodyne fashion and generate the RF signal.

### FIELD OF INVENTION

The present invention relates to a device for generating and modulation a high-frequency signal.

### BACKGROUND INFORMATION

Wireless communication systems in the field of cellular mobile telephony are very popular. In addition to voice transmission, more and more broadband services such as data and image transmission are in the foreground of today's cellular mobile telephony devices.

Such wireless communication systems require very high frequencies. A frequency range above 30 GHz, for example, is of great interest. This is because the frequency spectrum is very crowded in frequencies below this range. Thus, it can be difficult to find frequency bands in this range that are still available.

With frequencies of 24 GHz and 60 GHz relatively strong atmospheric damping takes place. This often can allow frequency channels to be reused. For a cellular configuration, these frequencies may be useful for obtaining high spectral efficiency. Moreover, this frequency range makes it possible to use very small dimensions for transmitting and receiving antennas.

When such high frequencies are involved, the transmitting devices, for example, require special conductors because of the current displacement effect (skin effect). For economic reasons, the signal transmission from a transmission device to a transmitting antenna is implemented with the aid of hollow conductors. However, hollow conductors are rather expensive. They are also relatively susceptible to faults.

Optical signal carriers, which are highly immune to interference and are considered inexpensive, may be used.

In the reference entitled “Project P816-PF, Implementation frameworks for integrated wireless optical access networks, Deliverable 4, EURESCOM (2000)”, a so-called radio-over-fiber method is mentioned. Apparently, in this case, a high-frequency radio signal to be transmitted is superposed onto an optical signal in a suitable manner in order to then be transmittable on a standard glass fiber. Glass fibers are known to have extremely low damping of approximately 0.2 dB/km. As a result, a location where an RF (radio frequency) signal is generated and a location where the RF signal is emitted may be spaced apart by a very large distance. This distance may even amount to several kilometers. In a radio-over-fiber system, the antenna is utilized solely for emitting the signal and therefore may have a simple design. The entire complexity is found in a single control station, which is connected to a multitude of antennas at remote locations in a star-like configuration via glass fibers. This approach offers many advantages as far as cost savings, frequency planning and handover are concerned.

The so-called heterodyne technology is available for generating an RF carrier in an optical fiber. This technology is based on the fact that only the intensity of the light, but not the intensity of the field of the involved waves is able to be measured. Heterodyne signal transmission requires two waves that differ in their frequency. The frequency difference of these waves is of the same size as the frequency of the required RF signal itself. For all intents and purposes, the two frequency-shifted waves bring about a beat frequency that corresponds to the RF signal. Generally, a re-conversion of the RF signal from the optical into the electric range may be implemented via a photodiode. Like other optical measuring devices, this element cannot detect the electric fields of the two optical waves. It can measure only the light intensity of the overall field, which, however, is a quadratic function of the sum of the field variables. In addition to the fundamental frequencies of the two waves involved, the overall intensity therefore also includes frequencies that correspond to twice the frequency value. The summation and difference frequencies are present in addition. The photodiode can follow only the difference frequency between the two waves, so that its output current is proportional to the RF signal.

That is to say, in heterodyne technology, two waves that differ in frequency are superposed in the photodiode. The output current of the photodiode, which is produced by the beat frequency and corresponds to the RF signal, is able to be amplified and emitted by an antenna.

The reference by M. Hickey, R. Marsland and T. Day, entitled “Lasers and Optronics,” Jul. 15 (1994), involves the use of two lasers used in a method for obtaining two optical waves having different frequencies. Via the current or the temperature, both lasers are adjusted in such a way that they exhibit the required difference in frequency. However, the lasers have a random phase difference because they operate independently of each other. This manifests itself as phase noise.

Optoelectronic circuits, for instance as an analogon to a phase control circuit configured as PLL (phase-locked loop), are available for regulating such a phase difference. Their use allows one of the two lasers to be controlled continuously and adjusted appropriately on the basis of its output signal.

Another approach is the use of three lasers. The third laser is employed as reference device, as a master, and modulated at a relatively low frequency. The two other lasers, which are therefore operating as slaves, are coupled to positive and negative sidebands of the master laser in a phase-locked manner. This method is known from the reference by R. P.Braun et al., entitled “Wireless Personal Comm.,” 46, 85 (2000).

### SUMMARY OF INVENTION

The present invention provides a method and device which allows the generation or modulation of high-frequency signals in a simple and cost-effective manner.

In embodiments of the present invention, the RF signal is derived from only a single signal laser, so that no problems arise from a phase difference of two lasers and no measures are required for a phase control. Further, it allows the use of cost-effective optical elements.

Embodiments of the present invention are based on the realization that even a few milliwatts of optical pump output are sufficient to amplify a wave propagating in optical waveguides or optical fibers counter to the pump wave, using stimulated Brillouin scattering (SBS).

In such an exemplary process, the output of the pump lasers is dimensioned or adjusted in such a way that it lies below the threshold value required to generate an oppositely directed wave from the noise in the fiber. Due to the narrow bandwidth of SBS it is possible to amplify only specific narrow-band components of a broadband frequency mix.

Because of the SBS effect in the optical waveguide and the narrow bandwidth related to the SBS effect, only two narrow-band components of the broadband frequency mix are amplified according to the present invention, that is to say, precisely those for which the two pump waves propagating in the opposite direction exhibit a particular shift in frequency.

In principle, the optical signal source for generating the broadband frequency mix according the present invention may be configured as broadband coherent source, for example, as a Fabry-Perot laser. This source may also be a broadband, non-coherent source, for example, a photodiode or an erbium-doped fiber amplifier. For practical purposes, the optical signal source is configured as a signal laser, which generates an optical signal of a constant wavelength. This approach produces low-noise performance.

In embodiments of the present invention, for example, all of the required components are standard products of optical communication technology, which are produced in large lot numbers and therefore obtainable at low cost.

Compared to other methods, the method according to the present invention may involve requiring no complicated, delicate and expensive components that can be produced only by facilities having the proper equipment.

An optical fiber in the kilometer range may be used to transmit a high-frequency signal generated in the manner of the present invention, so that a transmitting antenna and the device itself may be situated at a large distance from each other.

Furthermore, an output frequency generated in this way may be tuned in an uncomplicated manner; an additional modulation of the RF signal using the useful information is likewise easy to accomplish.

In embodiments, the present invention uses pump lasers to inject two pump waves propagating in the optical waveguide. Pump lasers are obtainable as optoelectronic standard components and thus are relatively inexpensive. The amplification bandwidth of the SBS may be adapted to the individual requirements by modulation of the pump lasers.

The two pump lasers ensure that two narrow-band components of the broadband frequency mix, shifted by a specific frequency, are amplified by SBS.

In embodiments of the present invention, the broadband frequency mix is generated by triggering an optical modulator connected to the output of the signal laser with the of a generator having a fixed frequency. The output voltage of the generator is selected such that the modulator is operating in a non-linear range of its characteristic curve, so that multiples of the generator frequency are present in the frequency spectrum of the modulated optical signal in the form of upper and lower sidebands. The frequency spacing of the sidebands is a function of the generator frequency.

For practical purposes, a polarizer is provided between the modulator and the signal laser. Since the modulator in back of the signal laser can modulate only light having a particular polarization, the polarizer adjusts it accordingly, without costly measures. The modulator may be configured as Mach-Zehnder modulator, which is likewise obtainable as a relatively inexpensive component.

For example, if the generator is operated at a frequency of 10 GHz, then frequency components of f+−10 GHz, f+−20 GHz, f+−30 GHz etc. are included in the spectrum of the modulated optical signal having frequency f. For an amplification of two sidebands of this frequency mix, the two pump lasers have an output signal of a frequency, or have a frequency that is adjustable, in such a way that it is 11 GHz higher in each case than the sideband to be amplified.

That is to say, since the two waves to be superposed in heterodyne fashion at the photodiode are derived from the same source through the non-linear characteristic curve of the modulator, they have a fixed mutual phase relation. As a result, no phase noise occurs in the output signal.

In embodiments of the present invention, there are other approaches for obtaining the frequency mix, such as a broadband coherent or non-coherent light source.

In embodiments of the present invention, the frequency mix and the two pump waves propagate in mutually opposite directions in an optical waveguide. An optical waveguide within the meaning of this specification is any optical element for guiding the light. The optical waveguide may be an optical fiber, in particular a glass fiber, such glass fiber preferably being developed as a highly non-linear fiber or as micropatterned fiber, although inexpensive standard single-mode glass fibers may be used as well.

A phase shift between the two amplified narrow-band components of the frequency mix due to fiber dispersion or non-linear effects such as a self- or cross-phase modulation, may be compensated by suitable coordination of the fiber length.

In embodiments of the present invention, in order to produce a simple optoelectronic device having few components, for which standard components may be used as well, it is additionally provided that the outputs of the two pump lasers be combined via a coupler at whose output a circulator is connected. The output of the optical modulator and an output of the circulator are connected to the optical waveguide or the fiber, for example, in such a way that the harmonic waves of the signal laser are able to propagate in the opposite direction to the two pump waves.

In another embodiment of the present invention, a photo element, such as a photodiode, is provided, which is configured in such a way that heterodyne superpositioning of the two amplified harmonic waves is brought about, the output current of the photo element following a beat frequency formed by the amplified harmonic waves and corresponding to an RF frequency. Such a measure may make it possible to lower the costs since fewer components are required for suitable signal generation and photodiodes are able to be obtained as inexpensive components.

In embodiments of the present invention, it is useful if the photodiode is simply post-connected at an output of the circulator. The output of the photodiode may then be connected to an antenna or an antenna amplifier.

The output current of the photodiode is a function of the overall intensity of the optical signal. This in turn is a function of the sum of the squares of the amplitudes of the two harmonic waves. Accordingly, the overall intensity includes frequency components having the fundamental frequency of the included harmonic waves, their double in each case, as well as summation and difference frequencies between them. With the exception of the difference frequency, all of these frequencies lie in the optical range. The temporal change in the output current of the photodiode is therefore able to follow only the beat frequency between the two amplified waves.

In embodiments of the present invention, the photodiode detects a single frequency so to speak, i.e., only the difference frequency between the two harmonic waves. However, the difference frequency corresponds precisely to the RF signal. As a result, the output current of the photodiode changes periodically with the frequency of the RF signal.

In embodiments of the present invention, the output of the pump waves in the optical waveguide lies below the threshold value of SBS required to generate an oppositely propagating wave from the noise in the fiber. The harmonic waves generated by the optical modulator operating in the range of its non-linear characteristic curve propagate in the opposite direction to the two pump waves, so that, because of the narrow bandwidth of SBS, only the two harmonic waves for which the pump waves exhibit a specific shift in frequency are able to be amplified. All other harmonic waves are attenuated by the damping of the optical waveguide. As a consequence, there may be only two strong waves available at an output port of the circulator.

For the system to function in the aforedescribed manner, the entire transparency range of the individual optical waveguide medium is feasible in principle. However, above all, the C band of optical telecommunication involves inexpensive components (lasers, photodiodes, circulators and the like) available in this range.

In embodiments of the present invention, the light source, such as the signal laser, may have a C band frequency, for example a frequency of 193.4 THz, which corresponds to a wavelength of approximately 1550 nm, and the waves propagate in a standard single mode glass fiber. In that case, the optical modulator generates harmonic waves that are grouped about 193.4 THz of the fundamental wave in the form of positive and negative sidebands having a shift in frequency defined by the generator. To amplify two of these harmonic waves, the two pump waves, which propagate in opposite directions in the optical waveguide, must have a frequency that is approximately 11 GHz higher than the respective harmonic wave to be amplified.

The device may then be used in a radio communications network, in particular a mobile-telephony network (cellular network) or in a master station of a radio communications network.

Embodiments of the present invention are suited for the field of broadband services such as data or video transmission. The approach according to the present invention is also of interest in the context of wireless computer networks (WLAN). While wire-bound local computer networks (Ethernet LAN) transmit 10 Gbit/s, for example, wireless systems reach several 10 mbit/s (such as 54 Mbit/s for IEEE 802.11). The present invention is able to achieve considerably higher values in a cost-effective manner.

The present invention as well as additional advantages of the invention are elucidated in greater detail with the aid of the description of the figures.

### BRIEF DESCRIPTION OF THE DRAWINGS

FIG. 1 shows a block diagram of an embodiment of the present invention.

FIG. 2 shows a frequency spectrum diagram, i.e., downstream from a modulator, in back of the coupler, and downstream from an output of the circulator, according to an embodiment of the present invention.

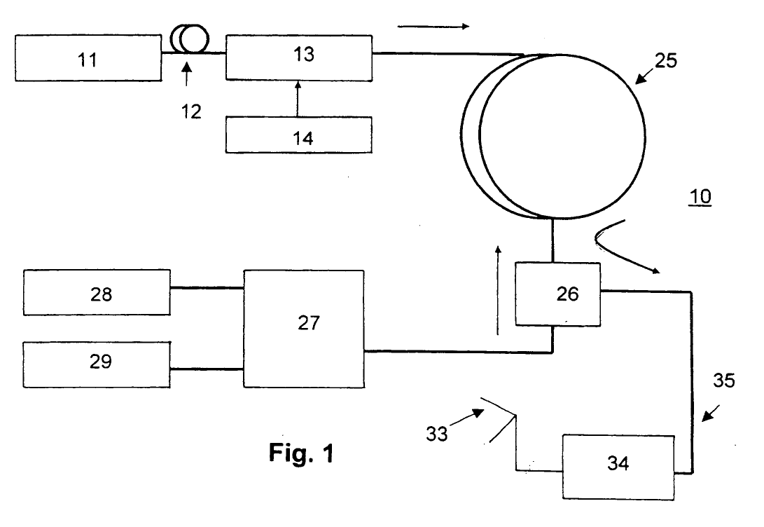

FIG. 1 shows an example of a device 10 according to the present invention, for example, a transmission device in a mobile telephony network.

Device 10 encompasses a signal laser 11, which generates coherent light having a wavelength or frequency SF in an optical telecommunications band, e.g., the C band (1528.77-1560.61 nm or 196.1-192.1 THz).

The restriction of the device according to the present invention to the C band of optical information technology is not mandatory. Inexpensive optical components now are available in this range. If the system according to FIG. 1 is operated in another waveband, the wavelengths of pump lasers 28, 29 and the signal laser must be adjusted to the conditions in this waveband. For example, the required shift in frequency will then no longer be 11 GHz.

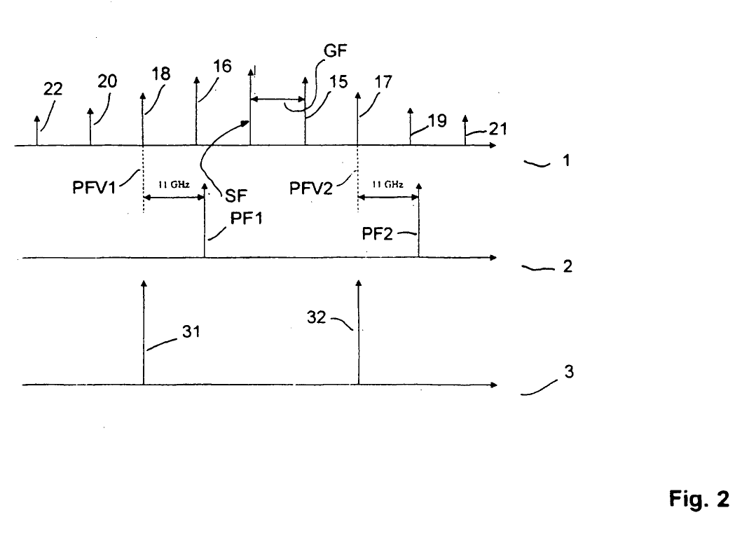

Situated in back of signal laser 11 is a polarizer 12 to enable the laser light of signal laser 11 to have a specific polarity. If a modulator 13, for example, a Mach-Zehnder modulator 13 as illustrated in FIG. 1, is to be used, the Mach-Zehnder modulator 13 is controlled on the basis of a fixed generator frequency GF, generator frequency GF being shown in FIG. 2; the set-up of a generator 14 connected to Mach-Zehnder modulator 13 is illustrated in FIG. 2.

FIG. 2 shows the frequency spectrum at three selected points of FIG. 1. Shown at the top is the spectrum after Mach-Zehnder modulator 13. In the middle, the spectrum behind a coupler 27 is illustrated. The output spectrum in back of a circulator 26 and in front of an input of a photodiode 34 is shown at the bottom.

An output voltage of generator 14 is selected such that Mach-Zehnder modulator 13 is operating in the non-linear range of its characteristic curve. In addition to the frequency of signal laser SF, frequencies that are shifted by a multiple of generator frequency GF are then part of the spectrum of the modulated signal as upper and lower sidebands.

Top section 1 of the diagram in FIG. 2 shows the optical spectrum downstream from Mach-Zehnder modulator 13. Since it is operated in the non-linear range of its characteristic curve, it generates upper sidebands 15, 17, 19 and 21, as well as lower sidebands 16, 18, 20 and 22, i.e., for instance, upper sidebands having the frequencies of +10 GHz, +20 GHz, +30 GHz, and lower sidebands of −10 GHz, −20 GHz, −30 GHz with respect to signal laser frequency SF of 193.4 THz, for instance. The frequency component of +10 GHz, which is denoted by 15, constitutes a first positive sideband; the frequency component of −10 GHz, which is denoted by 16, corresponds to a first negative sideband. Frequency components 18-22 and 17-21 constitute additional sidebands or harmonic waves. That is to say, in addition to the frequency of signal laser SF, upper and lower sidebands (harmonic waves) shifted by a multiple of generator frequency GF are present in the spectrum of the optical signal downstream from the modulator. The frequency spacing of these sidebands is a function of the frequency of generator 13.

With the aid of a temperature regulation, for instance, both pump lasers 28, 29 are adjusted in such a way that their output frequency PF1, PF2 is larger by, for example, approximately 11 GHz than the respective sideband 17, 18 to be amplified. DFB lasers, for instance, may be used as pump lasers 28, 29.

In order to protect both the signal and the pump lasers from destruction by returning wave components, optical insulators must be in place behind each of the three lasers. In the case of DFB laser diodes for use in optical telecommunication such insulators are advantageously already installed as standard equipment.

As long as the SBS bandwidth of, in particular, approximately 35 MHz is not undershot by frequency GF of generator 14 and the bandwidth of both pump lasers 28, 29, the output frequency is able to be adjusted at will by regulating the frequency of generator 14 and pump lasers 28, 29. In the most basic case, the output frequency of pump lasers 28, 29 may be regulated via a temperature and/or current modification. Other possibilities are offered by tunable laser systems and grating configurations, or by broadband lasers having a post-connected Faser-Bragg grating. The tuning of generator frequency GF and pump laser frequencies PF1 and PF2 is implemented via a shared control, for example.

As may additionally be gathered from FIG. 1, the output of Mach-Zehnder modulator 13 is coupled to the optical waveguide, for example, to a standard single mode fiber 25, which in turn is connected to a circulator 26 at its other end. Circulator 26 is supplied by an optical coupler 27 carrying the two pump frequencies PF1 and PF2, as shown by center region 2 of the diagram in FIG. 2.

The harmonic waves of signal laser 11 propagate in the opposite direction to the two pump laser waves 28, 29.

The output of the pump waves in fiber 25 lies below the SBS threshold value required to generate a Stokes wave from the noise in optical waveguide 25. However, it is high enough to amplify spectral components of the oppositely directed frequency mix.

An amplification takes place only if the pump waves have a particular shift in frequency relative to the oppositely-directed waves to be amplified, and amplified is only that which fits into the amplification bandwidth of the SBS in the utilized optical waveguide. In the standard single mode glass fiber (SSMF) 25, the shift in frequency amounts to approximately 11 GHz with a pump wave length of 1550 nm, and the amplification bandwidth is approximately 35 MHz. The shift in frequency between the harmonic waves to be amplified and the two pump lasers is illustrated in the center region of the diagram in FIG. 2.

As a result of the relatively narrow bandwidth of the SBS, only the two harmonic waves or sidebands 18 and 19, for example, are amplified. All other harmonic waves or sidebands 15, 17, 21 and 16, 20, 22, as well as the fundamental wave (signal frequency SF) are attenuated by the fiber damping. In order for this to be achieved, optical waveguide 25 must have a corresponding length. Accordingly, the two strong waves 31, 32 are available at the output of circulator 26, as illustrated by lower section 3 of the diagram in FIG. 2. The frequency mix is therefore modified according to the present invention.

Circulator 26 is employed to inject and decouple the waves as a function of the direction. On the one hand, it allows the pump waves to be injected into the end of fiber 25, as shown in FIG. 1. At the same time, it may be used to decouple harmonic waves 17, 18 of signal laser 11 amplified in fiber 25 by the SBS.

It should be noted that the SBS is the non-linear effect having the smallest threshold value. Other types of fiber also allow an SBS and may be utilized accordingly. In that case, the shift in frequency of pump lasers 28, 29 must be adapted to the type of fiber. The required length of fiber 25 depends on the type of fiber utilized.

The two amplified harmonic waves 17, 18 are superposed in a photo element, for example, a photodiode 34, in a heterodyne manner. The output current of photodiode 34 is a function of the overall intensity of the optical signal, which in turn is a function of the square of the sum of the amplitudes. Since photodiodes are too slow for the summation frequency and the harmonics of the optical frequencies involved, the output current of photodiode 34 follows only the beat frequency between the two harmonic waves amplified by the SBS effect, which, however, corresponds precisely to the desired RF frequency. For example, if generator frequency GF is 10 GHz, this will result in a frequency of 40 GHz for the beat via the two sidebands or harmonic waves 17, 18. In contrast, if the two third sidebands or harmonic waves 19, 20 are amplified, 60 GHz result for the RF signal. A correspondingly lower or higher RF frequency results if other harmonic waves are amplified.

In embodiments of the present invention, a generator frequency of 5 GHz, for example, results in frequencies or beat frequencies of 10, 20, 30 GHz etc., depending on which harmonic waves are amplified. The output frequency supplied by the photodiode may be adjusted accordingly by regulating the frequency of the generator (GF) and the two pump lasers (PF1 and PF2).

To emit the RF signal, the output of photodiode 34 is connected to antenna 33; an antenna amplifier may be interposed as well, as illustrated in FIG. 1.

With the exception of a photodiode 34, all components of the device are disposed at a distance of, for instance, a few kilometers from an antenna 33. The output of the circulator is optically connected to photodiode 34 via an optical transmission fiber 35 having a length in the kilometer range and low damping (e.g., approximately 0.2 dB/km). If the damping of the optical transmission fiber becomes excessive in the case of large distances, optical amplifiers available from optical information technology such as erbium-doped fiber amplifiers may be utilized to amplify the signal.

Optical waveguide 25 in which the SBS takes place may also be used to transmit the RF signal across large distances between control and transmission station. In this case, signal source 11 together with polarizer 12, modulator 13 and generator 14 is situated at the location of the control station, while the two pump lasers (28, 29), coupler 27, circulator 26, photodiode 34 and antenna 33 are located a few kilometers away, at the location of the transmitting station.

If the output signal is modulated in the manner of the present invention, it may also be used directly as optical input signal for radio-over-fiber systems.

If the present invention is to be utilized for mobile radio-communication systems such as cellular mobile telephony or WLAN, for example, the RF signal must additionally be modulated with the useful information of the corresponding system.

A modulation of the RF signal with a useful signal is able to be implemented by an additional optical modulator, which may be set up at any point in the system. Easier and less expensive is a direct modulation of the signal (11) or one of the pump lasers (28, 29). For instance, if the control current of the lasers is modified as a function of the useful signal, a change in the wavelength or frequency of their output signals will result. If the shift in frequency between signal and pump lasers does not precisely correspond to the frequency shift required for SBS (11 GHz with a bandwidth of 35 MHz), amplification by SBS cannot take place. The change in temperature or current of the lasers in the clock pulse of the useful information therefore causes a variation of the shift in frequency between signal and pump laser. If, and only if, it corresponds to the SBS shift for both sidebands, a superposing signal is produced in the photodiode. Accordingly, an intensity modulation of the RF signal as a function of the useful information comes about at photodiode 34.

A direct and easily implementable modification of the output signal of generator 14 also leads to a modulation of the RF signal. In a frequency variation of generator signal 14, the output spectrum of the optical modulator (FIG. 2, top) is shifted relative to the frequencies of the pump lasers (FIG. 2, center). Due to the small bandwidth of the SBS, even a slight shift has the result that Brillouin scattering will no longer take place in the fiber. The intensity of the RF signal at photodiode 34 is thereby likewise modulated again.

In the event that the amplification bandwidth of the SBS is insufficient for applications having an extremely high bit rate, it is able to be enlarged and adapted to the individual conditions by an additional modulation of pump lasers 28, 29, as elucidated in greater detail in the publication “T. Tanemura, Y. Takushima, K. Kikuchi, Opt. Lett. 27, 1552 (2002)”.

Even highly non-linear and/or micropatterned fibers are able to be used. This is described in greater detail in “T. Schneider, Nonlinear Optics in Telecommunications, Springer Berlin, Heidelberg, New York (2004)”.

As an alternative to the device shown in FIG. 1, it is possible to dispense with modulator 13 and generator 14. If a broadband coherent source such as a Fabry-Perot laser is used as signal laser 11, it already has a broad spectrum. Parts of this spectrum are able to be amplified in fiber 25 in the afore-described manner, using the SBS, and superposed in photodiode 34 in a heterodyne manner.

Instead of the broadband coherent source, a broadband, non-coherent source such as a photodiode, for example, also may be used as signal laser 11. However, in this case the phase relation between the spectral components is no longer constant, which leads to phase noise in the RF signal. A light source comparable to the signal laser may therefore also be a photodiode.

If signal laser 11 is directly triggered by generator 14, then it is likewise possible to dispense with optical modulator 13. The output power of generator 14 must then be high enough for the signal laser to be operating in the non-linear range of its characteristic curve. In this case the output spectrum of signal laser 11 has harmonic waves of the generator frequency, which are individually amplified by pump lasers 28, 29 in the afore-described manner and superposed in heterodyne fashion.

Embodiment of the present invention involve a signal laser 11 is coupled to optical waveguide 25 via modulator 13, for example, as shown in FIG. 1. Modulator 13 is connected to generator 14. The modulator is operated in the non-linear range of its characteristic curve, which causes harmonic waves to be produced. Via the SBS effect, certain harmonic waves are amplified by the two oppositely directed pump waves 28, 29 in the fiber; all other waves are attenuated by the fiber damping. The RF signal is produced by the heterodyne superimposition of the two waves in a photodiode 34.

The present invention is not limited to the illustrated examples. Individual features of this description may be combined with each other.

What is claimed is:

1-26. (canceled)

27. A device having a plurality of lasers for generating and modulating a high-frequency signal for a wireless communication network, having an optical waveguide, wherein
a) a signal source is provided, which generates an optical signal and is disposed on one side of the optical waveguide;
b) at least one means is provided, which generates harmonic waves in the optical waveguide that propagate as frequency mix;
c) two pump lasers are provided to inject a signal on an opposite side of the optical waveguide, which are adapted in such a way that, together, they amplify two harmonic waves of the frequency mix by stimulated Brillouin scattering, and the rest of the harmonic waves is attenuated by damping in the optical waveguide.

28. The device of claim 27, wherein the optical signal source is designed as a signal laser generating an optical signal having a constant wavelength.

29. The device of claim 27, wherein the optical signal source is designed as one of a broadband coherent source, a Fabry-Perot laser, a broadband non-coherent source, a photodiode, and an erbium-doped fiber amplifier.

30. The device of claim 27, wherein the means is an optical modulator, which is operated in a range of its non-linear characteristic curve and is designed as controllable by a generator, the modulator being disposed between the signal laser and the optical waveguide.

31. The device of claim 30, wherein a generator is coupled to the pump lasers in such a way that it allows an adjustment of the frequency of the high-frequency signal.

32. The device of claim 29, wherein a polarizer is provided between the modulator and one of the signal source and the signal laser.

33. The device of claim 27, wherein the optical modulator is designed as a Mach-Zehnder modulator.

34. The device of claim 27, wherein the optical modulator is designed as an electro-absorption modulator.

35. The device of claim 27, wherein the means is one of the signal source and the signal laser, which is triggered in the non-linear range of its characteristic curve and generates the required harmonic waves itself.

36. The device of claim 27, wherein each of the pump lasers has an output signal having a frequency that is higher, by the frequency shift of the Brillouin scattering in the utilized optical waveguide, than the respective sideband to be amplified, and the pump lasers are dimensioned such that the output of their two pump waves leads to an amplification of sidebands in the optical waveguide.

37. The device of claim 27, wherein the outputs of the two pump lasers are combined via a coupler at whose output a circulator is connected.

38. The device of claim 27, wherein one of a photo element and a photodiode is provided, which is designed in such a way that heterodyne superpositioning of the two amplified harmonic waves is produced, its output current following a beat frequency formed by the amplified harmonic waves and corresponding to an RF frequency.

39. The device of claim 38, wherein one of an antenna and an antenna amplifier is connected to one output of the one of photo element and photodiode.

40. The device of claim 38, wherein the one of photo element and photodiode is connected to an output of the circulator.

41. The device of claim 40, wherein the circulator is connected to the one of photo element and photodiode via an optical transmission fiber having a length in a kilometer range.

42. The device of claim 27, wherein both the signal laser and the pump lasers have a laser light having a wavelength in the C band of optical telecommunications.

43. The device of claim 27, wherein the optical waveguide is designed as a glass fiber.

44. The device of claim 43, wherein the optical waveguide is designed as a highly non-linear fiber.

45. The device of claim 43, wherein the optical waveguide is designed as micropatterned fiber.

46. The device of claim 43, wherein the optical waveguide is a standard single mode glass fiber.

47. A method for generating a high-frequency signal via an optical waveguide for a wireless communication system, comprising:
an injection of a frequency mix encompassing harmonic waves at one end of the optical waveguide, and by an injection of two pump waves at the other end of the optical waveguide, the pump waves in each case amplifying a harmonic wave by stimulated Brillouin scattering, while the other harmonic waves are attenuated by optical damping in the optical waveguide.

48. The method of claim 47, comprising heterodyne superpositioning of the two amplified harmonic waves.

49. The method of claim 47, comprising one of a modulation and an additional modulation, using useful information superposed onto at least one of the harmonic waves.

50. The method of claim 49, wherein the useful information is superposed onto the harmonic waves by a modulation of a signal laser.

51. The method of claim 49, wherein the useful information is superposed onto one of the harmonic waves by a modulation of a pump laser.

52. The method of claim 47, wherein useful information is superposed onto the harmonic waves by an additional modulation of the generator.
